(19) United States
(12) Patent Application Publication
(10) Pub. No.: US 2026/0145211 A1
(43) Pub. Date: May 28, 2026

(54) WIRE MATERIAL CLEANING DEVICE, METHOD, AND USE

(71) Applicants: China Academy of Machinery Zhengzhou Research Institute of Mechanical Engineering Co., Ltd., Zhengzhou (CN); Material Research Institute of Henan Academy of Sciences, Zhengzhou (CN)

(72) Inventors: Aiguo LI, Zhengzhou (CN); Weimin LONG, Zhengzhou (CN); Yuan LI, Zhengzhou (CN); Sujuan ZHONG, Zhengzhou (CN); Jian QIN, Zhengzhou (CN); Quanbin LU, Zhengzhou (CN); Yafang CHENG, Zhengzhou (CN)

(73) Assignees: China Academy of Machinery Zhengzhou Research Institute of Mechanical Engineering Co., Ltd., Zhengzhou (CN); Material Research Institute of Henan Academy of Sciences, Zhengzhou (CN)

(21) Appl. No.: 19/003,844

(22) Filed: Dec. 27, 2024

(30) Foreign Application Priority Data
Nov. 28, 2024 (CN) 2024117375658

(51) Int. Cl. B08B 6/00; B08B 13/00

(52) U.S. Cl. CPC B08B 6/00; B08B 13/00

(57) ABSTRACT

The present disclosure provides a wire material cleaning device, method, and use. The present disclosure provides a wire material cleaning device, including a charged dust collecting unit, wherein the charged dust collecting unit comprises a corona wire and a tubular dust-collecting anode plate, and the corona wire is located at a center position in an axial direction of the tubular dust-collecting anode plate.

### CROSS-REFERENCE TO RELATED APPLICATION

The present disclosure claims priority to Chinese patent Application No. 2024117375658, filed with the Chinese Patent Office on Nov. 28, 2024, entitled “WIRE MATERIAL CLEANING DEVICE, METHOD, AND USE”, the entire contents of which are incorporated herein by reference.

### TECHNICAL FIELD

The present disclosure relates to the technical field of wire material cleaning, and in particular to a wire material cleaning device, method, and use.

### BACKGROUND ART

The surface cleanliness of the bonding wire has a great influence on the properties of the bonding wire itself and the bonding properties. The traditional preparation process for bonding wires is to apply a drawing solution and annealing solution during the drawing and annealing process, which can lubricate wires and prevent them from sticking. However, metal ions and air dust in the drawing solution and annealing solution will remain on the surface of the wire during the wire preparation process. These surface particles will be embedded inside the bonding wire or remain on the surface during the further drawing or annealing rewinding process, which will deteriorate the mechanical property and the bonding property of the bonding wire.

At present, a cleaning method for the bonding wire is usually to install a cleaning tank at the back end of the bonding wire drawing device, so as to perform the bubble cleaning or additionally provide an ultrasonic cleaning device. However, in the above two methods, the bonding wires are immersed in the water, and stains after cleaning remain in the water, which is very easy to cause secondary pollution of the bonding wires. Moreover, if the ultrasonic cleaning is performed after the final annealing, it is easy to cause the wires to be stuck, which results in limited use. Additionally, it further needs to provide a winding system, an unwinding system and a tension system when the ultrasonic cleaning device is specially provided, which takes a high cost and large area.

In view of this, the present disclosure is proposed.

### SUMMARY

A first object of the present disclosure is to provide a wire material cleaning device. The particles on the surface of the wire material are charged with the aid of the current by the charged dust collecting unit, and the particles on the surface of the wire material are removed by electrostatic dedusting, which avoids the secondary pollution generated by the contact between the particles and the wire material. Moreover, the device is small and convenient, and can be integrated at the back end of the drawing or annealing device with a low cost and small area.

A second object of the present disclosure is to provide a wire material cleaning method, which can effectively remove particles on the surface of the wire material. It has a high efficiency and a good cleaning effect, and is particularly suitable for removing micron particles.

A third object of the present disclosure is to provide the use of the above wire material cleaning method in bonding wire cleaning.

In order to realize the above objects, the present disclosure adopts the following technical solutions.

In a first aspect, the present disclosure provides a wire material cleaning device, including a charged dust collecting unit, wherein
the charged dust collecting unit includes a corona wire and a tubular dust-collecting anode plate, and the corona wire is located at a center position in an axial direction of the tubular dust-collecting anode plate.

It includes at least one of the following features (1) to (5):
(1) a diameter of the corona wire is 0.2˜0.3 cm;
(2) a material of the corona wire includes stainless steel;
(3) an inner circle radius of the tubular dust-collecting anode plate is 1˜2 cm;
(4) a length of the tubular dust-collecting anode plate is 100˜300 mm; or
(5) a material of the tubular dust-collecting anode plate includes stainless steel or aluminum alloy.

Further, in the charged dust collecting unit, a center distance between the wire material and the corona wire is 0.11˜0.45 cm; and/or a voltage applied to the charged dust collecting unit is 14˜55 kV.

Further, the wire material cleaning device further includes a power source, wherein the corona wire is connected to a negative electrode of the power source, and the tubular dust-collecting anode plate is connected to a positive electrode of the power source; and/or
the wire material cleaning device further includes a conveying unit; the conveying unit includes an unwinding spool, a tension rod, a first guide wheel, a second guide wheel, and a winding spool arranged in sequence; and the charged dust collecting unit is arranged between the first guide wheel and the second guide wheel.

In a second aspect, the present disclosure further provides a wire material cleaning method, which adopts the wire material cleaning device as described above, including the following steps:
moving a wire material to be cleaned in a direction parallel to the corona wire and passing through the charged dust collecting unit, and charging particles on the surface of the wire material and collecting dust, so as to obtain a wire material after cleaned.

Further, the following relation is satisfied: U>30 Maδ(1+0.3/\sqrt{aδ})ln(b/a), where U is a DC voltage applied by the power source between the corona wire and the tubular dust-collecting anode plate in kV; M is a wire surface roughness coefficient; δ is a gas relative density; a is a radius of the corona wire in cm; and b is an inner circle radius of the tubular dust-collecting anode plate in cm.

Further, the following relation is satisfied:

$$x > \frac{U}{30 M δ ( 1 + 0.3 / \sqrt{a δ} ) ln ( b / a )} ,$$

where x is the center distance between the wire material and the corona wire in cm.

Further, the following relation is satisfied: l>v·(t_{c}+t_{col}), where l is the length of the tubular dust-collecting anode plate in m; t_{c} is a charging duration in s; t_{col} is a dust collection duration in s; and v is a moving speed of the wire material in m/s;

$${t}_{c} = \frac{τ A {d}_{p}}{6 π {q}_{s} {Z}^{2} {E}_{x} - A {d}_{p}} ,$$

where τ is a charging time constant in s; A is a van der Waals Hamaker constant between the particles and the wire material; dₚ is an equivalent diameter of the particles in m; qₛ is a saturation charge quantity of the particles in C; Z is a distance between the particles and the surface of the wire material in m; and

$${E}_{x} = \frac{U}{x ln ( b / a )}$$

in kV/cm; and

$${t}_{col} = \frac{7 μ {ln}^{2} ( b / a )}{5 {ε}_{0} {d}_{p} {U}^{2}} {\int }_{x}^{b} {r}^{2} ,$$

where u is an air viscosity coefficient in Pa·s; ε₀ is a vacuum dielectric constant; and r is a distance between the particles and a center of the corona wire in cm.

Further, a particle size of the particles removed by the wire material cleaning method satisfies the following relation:

$${d}_{p} \geq \frac{A ( {ε}_{r} + 2 )}{18 {π}^{2} {Z}^{2} {E}_{x}^{2} {ε}_{0} {ε}_{r}} ,$$

where A is the van der Waals Hamaker constant between the particles and the wire material; Z is the distance between the particles and the surface of the wire material in m;

$${E}_{x} = \frac{U}{x ln ( b / a )} ,$$

where Eₓ is an electric field strength at the wire material in kV/cm; ε₀ is the vacuum dielectric constant; and εᵣ is a relative dielectric constant of the particles.

In a third aspect, the present disclosure further provides the use of the above wire material cleaning method in the bonding wire cleaning.

Compared with the prior art, the method of the present disclosure includes the following beneficial effects.

1. In the wire material cleaning device of the present disclosure, the particles on the surface of the wire material are charged with the aid of the current by the charged dust collecting unit, and the particles on the surface of the wire material are removed by electrostatic dedusting, which effectively avoids the secondary pollution caused by the contact between the particles and the wire material in the traditional ultrasonic cleaning.

2. In the wire material cleaning device of the present disclosure, the particles on the surface of the wire material can be effectively removed by using micro-electrostatic dust removal, which has a high efficiency and a good cleaning effect, and is particularly suitable for removing the micron particles.

3. Compared with the traditional ultrasonic cleaning device, the wire material cleaning device of the present disclosure has advantages of smaller size, lower cost, and smaller area. It can be integrated behind the drawing machine and can also be integrated behind the annealing machine, so as to be a final cleaning method, which avoids the problems of wire sticking and abnormal winding.

### BRIEF DESCRIPTION OF DRAWINGS

In order to more clearly illustrate the technical solutions of the embodiments of the present disclosure, the drawings to be used in the embodiments will be briefly introduced below. It should be understood that the following drawings only show certain embodiments of the present disclosure, and therefore should not be regarded as a limitation of the scope. Other relevant drawings can be obtained from these drawings by a person of ordinary skill in the art without inventive efforts.

FIG. 1 shows a schematic structure diagram of a wire material cleaning device of the present disclosure.

FIG. 2 shows a schematic diagram of corona discharge and charging of the present disclosure.

FIG. 3 shows a curve of a space electric field strength of a charged dust collecting unit of the present disclosure.

FIG. 4 shows a picture of a particle adsorbed on a surface of a bonding wire of the present disclosure.

FIG. 5 shows a curve of a migration velocity of particle dust collection of the present disclosure.

FIG. 6 shows a time curve of particle dust collection of the present disclosure.

FIG. 7 shows a surface topography diagram of an uncleaned bonding wire of the present disclosure.

FIG. 8 shows a surface topography diagram of a bonding wire after ultrasonic cleaning of the present disclosure.

FIG. 9 shows a surface topography diagram of a bonding wire after cleaned in Example 1 of the present disclosure.

FIG. 10 shows a curve of a space electric field strength of a charged dust collecting unit in Example 2 of the present disclosure.

FIG. 11 shows a curve of a space electric field strength of a charged dust collecting unit in Example 3 of the present disclosure.

### REFERENCE NUMBERS

11—corona wire; 12—tubular dust-collecting anode plate; 2—power source; 3—wire material; 41—unwinding spool; 42—tension wheel; 43—first guide wheel; 44—second guide wheel; 45—winding spool; 46—tension rod; and 47—servomotor.

### DETAILED DESCRIPTION OF EMBODIMENTS

The technical solutions of the present disclosure will be clearly and completely described below in conjunction with the drawings and the specific embodiments. It will be understood by those skilled in the art that the embodiments described below are partial embodiments of the present disclosure and not all of them, and are used only to illustrate the present disclosure, and should not be regarded as a limitation of the scope of the present disclosure. Based on the embodiments in present disclosure, all other embodiments obtained by a person of ordinary skill in the art without inventive efforts all fall within the scope of protection of the present disclosure. Where specific conditions are not indicated in the examples, they shall be performed based on the usual conditions or those recommended by manufacturers. The reagents or instruments used without indication of the manufacturers are conventional products that can be purchased commercially.

A wire material cleaning device, method, and use of the present disclosure are described in detail below.

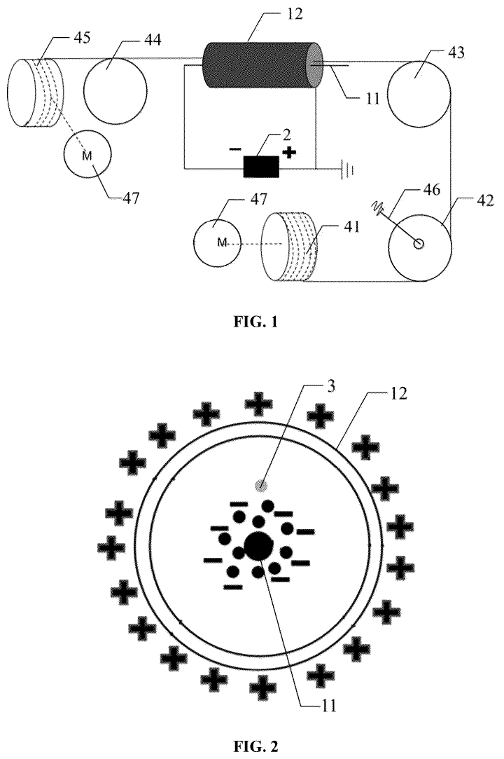

Referring to FIG. 1, some embodiments of the present disclosure provide a wire material cleaning device, including a charged dust collecting unit, wherein
the charged dust collecting unit includes a corona wire 11 and a tubular dust-collecting anode plate 12, and the corona wire 11 is located at a center position in an axial direction of the tubular dust-collecting anode plate 12.

In the wire material cleaning device of the present disclosure, the particles on the surface of the wire material are charged with the aid of the current, and the particles on the surface of the wire material are removed by electrostatic dedusting, which avoids the secondary pollution generated by the contact between the particles and the wire material. Moreover, the device is small and convenient, and can be integrated at the back end of the drawing or annealing device with a low cost and small area.

The wire material cleaning device of the present disclosure effectively avoids the secondary pollution caused by the contact between the particles and the wire material in the traditional ultrasonic cleaning by using the micro electrostatic field to remove dust.

In the wire material cleaning device of the present disclosure, the particles on the surface of the wire material can be effectively removed by using the micro-electrostatic dust removal, which has a high efficiency and a good cleaning effect, and is particularly suitable for removing the micron particles.

Compared with the traditional ultrasonic cleaning device, the wire material cleaning device of the present disclosure has the advantages of smaller size, lower cost, and smaller area. It can be integrated behind the drawing machine and can also be integrated behind the annealing machine, so as to be the final cleaning method, which avoids the problems of wire sticking and abnormal wire release.

The wire material is cleaned by using the wire material cleaning device of the present disclosure, that is, in this device, the particles on the surface of the wire material are charged to collect the dust. During the charging stage, gas molecules undergo the corona discharge under the action of a high-voltage electric field, so as to generate a large amount of free electrons and positive ions, i.e., gas ionization. The positive ions are immediately attracted by the corona wire and lose their charge; and the free electrons move toward the tubular dust-collecting anode plate under the action of the electric field, so as to fill the space between two electrodes. When the wire material containing particles enters this region, the free electrons meet the particles and attach to the particles, so that the particles are negatively charged. After the charging stage is finished, it enters the dust collection stage. During the dust collection process, the electric field force on the particles is larger than the van der Waals force. The particles get rid of the adsorption of the wire material and move towards the tubular dust-collecting anode plate, so that the particles on the surface of the wire material are removed effectively.

In some embodiments of the present disclosure, the corona wire 11 is coaxial with the tubular dust-collecting anode plate 12.

In some embodiments of the present disclosure, a diameter of the corona wire 11 is 0.2˜0.3 cm. Typically, but not limiting, for example, the diameter of the corona wire 11 can be 0.2 cm, 0.25 cm, or 0.3 cm, or a range consisted of any two of them. The diameter of the corona wire adopts the above size, which is small, so that it is easy to integrate into the drawing and annealing devices.

In some embodiments of the present disclosure, a material of the corona wire 11 includes stainless steel.

In some embodiments of the present disclosure, a sectional shape of the corona wire 11 is circular.

In some embodiments of the present disclosure, a length of the corona wire 11 is larger than or equal to a length of the tubular dust-collecting anode plate 12. It can ensure that the electric field strength in the length direction of the tubular dust-collecting anode plate is consistent, and it is easy to install.

In some embodiments of the present disclosure, an inner circle radius of the tubular dust-collecting anode plate 12 is 1˜2 cm. Typically, but not limitingly, a thickness of the tubular dust-collecting anode plate 12 can be, for example, 1 cm, 1.5 cm, or 2 cm, or a range consisted any two of them.

The inner circle radius of the tubular dust-collecting anode plate affects the voltage to be applied, the space electric field strength, the duration of dust collection, and the length of the tubular dust-collecting anode plate.

In some embodiments of the present disclosure, the length of the tubular dust-collecting anode plate 12 is 100˜300 mm. Typically, but not limitingly, for example, the length of the tubular dust-collecting anode plate 12 can be 100 mm, 150 mm, 200 mm, 250 mm, or 300 mm, or a range consisted of any two of them.

The length of the tubular dust-collecting anode plate adopts the above size, which helps to ensure the dust collection efficiency and facilitates the installation and the device integration.

In some embodiments of the present disclosure, the material of the tubular dust-collecting anode plate 12 includes stainless steel or aluminum alloy.

In some embodiments of the present disclosure, in the charged dust collecting unit, a center distance between the wire material and the corona wire 11 is 0.11˜0.45 cm. Typically, but not limitingly, for example, in the charged dust collecting unit, the center distance between the wire material and the corona wire 11 can be 0.11 cm, 0.15 cm, 0.20 cm, 0.25 cm, 0.30 cm, 0.35 cm, 0.40 cm, or 0.45 cm, or a range consisted of any two of them.

In some embodiments of the present disclosure, the voltage applied to the charged dust collecting unit is 14˜55 kV. Typically, but not limiting, for example, the voltage applied to the charged dust collecting unit can be 14 kV, 20 kV, 25 kV, 30 kV, 35 kV, 40 kV, 45 kV, 50 kV, 55 kV, or a range consisted of any two of them.

In some embodiments of the present disclosure, the tubular dust-collecting anode plate 12 is fixed to the corona wire 11 by screws and nuts, which facilitates the disassembly, washing, and drying, so as to avoid the secondary pollution and reuse. In some embodiments of the present disclosure, the corona wire 11 is connected to the negative electrode of the power source 2, and the tubular dust-collecting anode plate 12 is connected to the positive electrode of the power source 2.

In some embodiments of the present disclosure, the tubular dust-collecting anode plate 12 is grounded.

The corona wire of the present disclosure is connected to the negative electrode of the power source, the breakdown voltage and the high stability are higher, and the dust removal efficiency for fine particles is higher.

In some embodiments of the present disclosure, the power source 2 includes a DC/DC direct current boost module.

The DC/DC direct current boost module outputs the high-voltage direct current. Specifically, it is to generate a low voltage pulse by the high-frequency oscillation; then it is to boost to a preset voltage value by the pulse transformer; and then it is to obtain the high-voltage direct current by the pulse rectification, so as to supply to the charged dust collecting unit.

In some embodiments of the present disclosure, the wire material cleaning device further includes a conveying unit; the conveying unit includes an unwinding spool 41, a tension wheel 42, a first guide wheel 43, a second guide wheel 44, and a winding spool 45 arranged in sequence; and the charged dust collecting unit is arranged between the first guide wheel 43 and the second guide wheel 44. Preferably, the tension wheel 42 is provided with a tension rod 46.

In some embodiments of the present disclosure, the conveying unit further includes a servomotor 47, and the servomotor 47 is connected to the unwinding spool 41 and the winding spool 45 respectively.

In some embodiments of the present disclosure, the unwinding spool 41 and winding spool 45 include the insulating material.

In some embodiments of the present disclosure, the wire material cleaning device further includes a support fixed module, and the support fixed module is used to fix the charged dust collecting unit.

Some embodiments of the present disclosure provide a wire material cleaning method adopting the above wire material cleaning device, including the following steps:
moving a wire material to be cleaned in a direction parallel to the corona wire 11 and passing through the charged dust collecting unit, and charging particles on the surface of the wire material and collecting dust, so as to obtain a wire material after cleaned.

In some embodiments of the present disclosure, an input voltage at the input end of the power source 2 is 12˜24 V, which can ensure the personnel safety.

In some embodiments of the present disclosure, the DC voltage U applied by the power source 2 between the corona wire 11 and the tubular dust-collecting anode plate 12 satisfies the following relation:

U>30 Maδ(1+0.3/\sqrt{aδ})ln(b/a), where U is a DC voltage applied by the power source between the corona wire and the tubular dust-collecting anode plate in kV; M is a surface roughness coefficient of the corona wire; δ is a gas relative density; a is a radius of the corona wire in cm; and b is an inner circle radius of the tubular dust-collecting anode plate in cm.

According to Peake's empirical formula, an initial electric field strength of the corona E_{c}=30Mδ(1+0.3/\sqrt{aδ}), where E_{c} is the initial electric field strength of the corona, kV/cm; δ is the gas relative density; M is the surface roughness coefficient of the corona wire, and M=1 for the smooth wire; and a is the radius of the corona wire in cm.

For example, if the corona wire has a radius a=0.1 cm, wherein M is 1 and δ is 1, E_{c} is 58 kV/cm.

The space electric field strength of the charged dust collecting unit is

$${E}_{r} = \frac{U}{r ln ( b / a )} ,$$

where Eᵣ is the space electric field strength in kV/cm; U is the DC voltage applied by the power source between the corona wire and the tubular dust-collecting anode plate in kV; r is the distance between the particles and the center of corona wire in cm; b is the inner circle radius of the tubular dust-collecting anode plate in cm; and a is the radius of the corona wire in cm, wherein U, b, and a should be set to ensure that the electric field strength generated on the surface of the corona wire Eₐ is larger than E_{c}, so as to generate the ionization of air near the corona wire; i.e., U>30 Maδ(1+0.3/\sqrt{aδ})ln(b/a) in kV.

For example, if a=0.1 cm, b=1 cm, M=1, and δ=1, the U>13.4 kV can satisfy the corona discharge requirement.

In some embodiments of the present disclosure, the center distance x between the wire material and the corona wire 11 satisfies the following relation:

$$x > \frac{U}{30 M δ ( 1 + 0.3 / \sqrt{a δ} ) ln ( b / a )} ,$$

the corona wire in cm; U is the DC voltage applied by the power source between the corona wire and the tubular dust-collecting anode plate in kV; δ is the gas relative density; M is the surface roughness coefficient of the corona wire; b is the inner circle radius of the tubular dust-collecting anode plate in cm; and a is the radius of the corona wire in cm.

In order to avoid that the air gap between the wire material and the corona wire is broken through, so that the wire material is burned, the wire material should be located outside the corona region; and in order to ensure that the particles on the surface of the wire material are effectively charged, the wire material needs to be closed to the corona wire as possible. Therefore, the center distance between the wire material and the corona wire is

$$x > \frac{U}{30 M δ ( 1 + 0.3 / \sqrt{a δ} ) ln ( b / a )} .$$

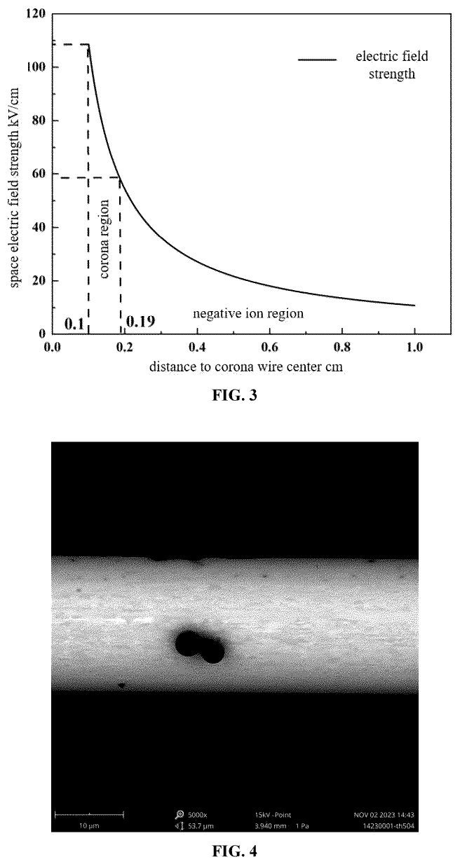

For example, if U is 25 kV, a curve of the space electric field strength of the charged dust collecting unit is shown in FIG. 3. The initial corona strength is 58 kV/cm. When the electric field strength is larger than this value, the gas in the region is ionized, and the electric field strength on the surface of the corona wire reaches a strongest state about 109 kV/cm. Therefore, the corona region is a range from the surface of the corona wire to a position with the initial corona strength, i.e., a space ranges from the center of the corona wire by 0.1˜0.19 cm. The wire material can be arranged from the center of the corona wire by 0.2 cm˜0.3 cm, and the corresponding electric field strength is 55˜43 kV/cm.

Referring to FIG. 2, during the charging process, the corona region has an electrostatic field Er that can sufficient to partially ionize the gas, wherein the gas molecules undergo the corona discharge in this electric field under the action of the high-voltage electric field, so as to generate a large amount of free electrons and positive ions, i.e., gas ionization. The positive ions are immediately attracted by the corona wire 11 and lose their charge; and the free electrons move toward the tubular dust-collecting anode plate 12 under the action of the electric field, so as to fill the space between two electrodes. When the wire material 3 containing particles enters this region, the free electrons meet the particles and attach to the particles, so that the particles are negatively charged.

In some embodiments of the present disclosure, the length l of the tubular dust-collecting anode plate 12 satisfies the following relation:
l>v·(t_{c}+t_{col}), where l is the length of the tubular dust-collecting anode plate in m; t_{c} is a charging duration in s; t_{col} is a dust collection duration in s; and v is a moving speed of the wire material in m/s;

$${t}_{c} = \frac{{τ Ad}_{p}}{6 {π q}_{s} {Z}^{2} {E}_{x} - {Ad}_{p}} ,$$

where τ is a charging time constant in s; A is a van der Waals Hamaker constant between the particles and the wire material; dₚ is an equivalent diameter of the particles in m; qₛ is a saturation charge quantity of the particles in C; Z is a distance between the particles and the surface of the wire material in m; and

$${E}_{x} = \frac{U}{x ln ( b / a )}$$

in K v/cm; and

$${t}_{col} = \frac{7 μ {ln}^{2} ( b / a )}{5 {ε}_{0} {d}_{p} {U}^{2}} {\int }_{x}^{b} {r}^{2} ,$$

where μ is an air viscosity coefficient in Pa·s; b is the inner circle radius of the tubular dust-collecting anode plate in cm; a is the radius of the corona wire in cm; co is the vacuum dielectric constant; dₚ is the equivalent diameter of the particles in m; U is the DC voltage applied by the power source between the corona wire and the tubular dust-collecting anode plate in kV; x is the center distance between the wire material and the corona wire in cm; and r is the distance between the particles and a center of corona wire in cm.

Referring to FIG. 4, the surface particle size of the wire material, such as a bonding wire, is usually in a range of 2˜10 μm. After the wire material enters the charging area, the particles are charged by the electric field. The charged particles are adsorbed on the surface of the wire material by the van der Waals force of the wire material on the one hand, and directed to the tubular dust-collecting anode plate by the electric field force on the other hand.

In some embodiments of the present disclosure, the particle size of the particles removed by the wire material cleaning method satisfies the following relation:

$${d}_{p} \geq \frac{A ( {ε}_{r} + 2 )}{18 {π}^{2} {Z}^{2} {E}_{x}^{2} {ε}_{0} {ε}_{r}} ,$$

where dₚ is the equivalent diameter of the particles in m; A is the van der Waals Hamaker constant between the particles and the wire material; Z is the distance between the particles and the surface of the wire material in m;

$${E}_{x} = \frac{U}{x ln ( b / a )} ,$$

where Eₓ is an electric field strength at the wire material in k V/cm; ε₀ is the vacuum dielectric constant; and εᵣ is a relative dielectric constant of the particles.

The van der Waals force plays a main role for adhesion of fine dust particles,

$${F}_{v} = \frac{A {d}_{p}}{6 π {Z}^{2}} ,$$

where A is the van der Waals Hamaker constant between the fine dust particles and the wire material; an order of magnitude is 10⁻²⁰ J; dₚ is the equivalent diameter of the particles; and Z is the distance between the particles and the surface of the wire material. The van der Waals force usually plays a role in a range of 0.4˜10 nm, wherein when Z=0.4 nm, the van der Waals force is the largest, and the particles are the most stable.

The electric field force is Fₑ=qₚEₓ, where Eₓ is the electric field strength in kV/cm where the wire material is located, and

$${E}_{x} = \frac{U}{x ln ( b / a )} ;$$

qₚ is the amount of charge quantity of the particles, and qₚ is relative to time,

$${q}_{p} = \frac{{q}_{s}}{1 + τ / {t}_{c}} ;$$

and qₛ is the saturation charge quantity of particles in C,

$${q}_{s} = \frac{3 {ε}_{r}}{{ε}_{r} + 2} π {ε}_{0} {d}_{p}^{2} {E}_{x} ,$$

where εᵣ is the relative dielectric constant of the particles, wherein it is usually taken as 2˜8, and it is taken as 5 herein; ε₀ is the vacuum dielectric constant, ε₀=8.85×10⁻¹² C²/N·m; dₚ is the equivalent diameter of the particles in m; τ is the charging time constant in s;

$$τ = \frac{4 {ε}_{0}}{{N}_{0} e K} ,$$

where N₀ is the ion density in PCS/m³; e is the electron charge, and e=1.6×10⁻¹⁹ C; K is the ion mobility in m²/s·V; and t_{c} is the charging duration in s. When t=t_{c}, the charge quantity of the particles Fₑ=Fᵥ, and the charging stage ends, so that

$${t}_{c} = \frac{τ A {d}_{p}}{6 π {q}_{s} {Z}^{2} {E}_{x} - A {d}_{p}} .$$

The charge quantity of the particles

$${q}_{p} = \frac{{F}_{v}}{{E}_{χ}} = \frac{A {d}_{p} x ln ( b / a )}{6 π {Z}^{2} U}$$

at this time, and the minimum particle size requirement Fₑ=qₛEₓ>Fᵥ in the dust collection stage can be reached, i.e.,

$${d}_{p} \geq \frac{A ( {ε}_{r} + 2 )}{18 {π}^{2} {Z}^{2} {E}_{x}^{2} {ε}_{0} {ε}_{r}} .$$

For example, it takes x=0.2 cm, a=0.1 cm, b=1 cm, U=25 kV, Z=0.4 nm, εᵣ=5, and dₚₘᵢₙ=1.9 μm.

The typical values of No and K under atmospheric temperature conditions are taken as N₀=5×10¹⁴/m³ and K=2.2×10⁴ m²/(s·V), and then the charging time constant T=0.002 s. When the time t_{c}=τ, the charge quantity of the particles is half of the saturation charge.

For example, it takes x=0.2 cm, a=0.1 cm, b=1 cm, dₚ=1.9 μm, U=25 kV, Z=0.4 nm, and εᵣ=5. When t=t_{c}=0.047 s, the particle charge quantity qₚ=1.161×10⁻¹⁵ C.

It takes x=0.2 cm, a=0.1 cm, b=1 cm, dₚ=3 μm, U=25 kV, Z=0.4 nm, and ¿, =5. When t=t_{c}=0.0034 s, the particle charge quantity qₚ=1.833×10⁻¹⁵ C, at which time Fₑ=Fᵥ.

When t>t_{c} and Fₑ>Fᵥ, the particles will get rid of the adsorption of the wire material and move to the tubular dust-collecting anode plate, so that the particles enter the dust collection stage. During the dust collection process, the particles are subjected to a swing force of the air and the electric field force.

The swing force F_{D}=3πμdₚω, and the swing force prevents the particles from flying towards the tubular dust-collecting anode plate, where μ is the air viscosity coefficient, which usually takes a value of 17.9×10⁻⁶ Pa·s; ω is a migration velocity of the particles to the tubular dust-collecting anode plate in m/s; the electric field force Fₑ=qₚEᵣ. Assuming that the air belongs to the Newtonian fluid,

$${F}_{e} - {F}_{D} = {q}_{p} {E}_{r} - 3 π μ {d}_{p} ω = m \frac{d ω}{{dt}_{col}} ,$$

where m is a mass of the particles; t_{col} is the dust collection duration, then

$$ω = \frac{{q}_{p} {E}_{r}}{3 π μ {d}_{p}} ( 1 - {e}^{- \frac{3 π μ {d}_{p}}{m} {t}_{col}} ) , where {e}^{\frac{3 {πμd}_{p}}{m} {t}_{col}}$$

is very small and negligible. In the electric field, the migration velocity of the charged particles is

$$ω = \frac{dr}{dt} = \frac{{q}_{p} {E}_{r}}{3 π μ {d}_{p}} = \frac{{q}_{p} U}{3 π μ {d}_{p} r ln ( b / a )} = \frac{A x}{18 μ r {π}^{2} {Z}^{2}} ,$$

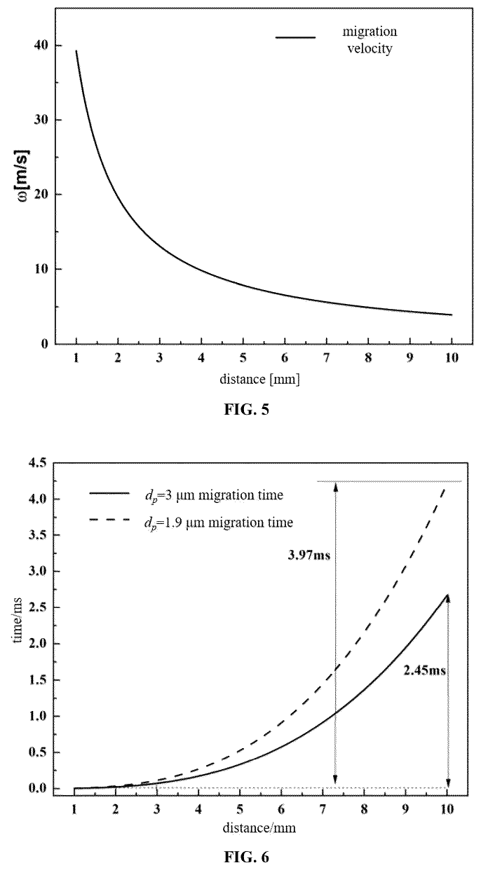

and the migration velocity is related to the center distance r of particles to the corona wire. The curve of the migration velocity of particle dust collection is shown in FIG. 5.

The duration required for the particles to be collected by the tubular dust-collecting anode plate is

$${t}_{col} = \frac{7 μ {ln}^{2} ( b / a )}{5 {ε}_{0} {d}_{p} {U}^{2}} {\int }_{x}^{b} {r}^{2} .$$

The curve of dust collection duration of the particles is shown in FIG. 6.

The particles simultaneously move at a certain moving speed v in the movement direction of the wire material during the dust collection stage. Therefore, the length of the tubular dust-collecting anode plate l>v·(t_{c}+t_{col}) is required to complete the particle charging and dust collection in the charged dust collecting unit.

If it takes x=0.2 cm, a=0.1 cm, b=1 cm, dₚ=1.9 μm, U=25 kV, t_{c}=47 ms, and t_{col}=3.97 ms, l>0.0765 m for v=1.5 m/s; and
it takes x=0.2 cm, a=0.1 cm, b=1 cm, dₚ=3 μm, U=25 kV, and t_{col}=2.45 ms, l>0.0088 m for v=1.5 m/s.

In some embodiments of the present disclosure, the radius a of the corona wire 11 is 0.1˜0.15 cm; and the inner circle radius b of the tubular dust-collecting anode plate 12 is 1˜2 cm. The applied voltage U is related to the values of a and b, wherein U is 14˜26 kV for b=1 cm, and U is 19˜55 kV for b=2 cm. The values of a, b, and U will also affect the value of the center distance x between the wire material and the corona wire 11, wherein the value of x ranges from 0.11 to 0.45 cm. The particle size dₚₘᵢₙ of the minimum clean dust is also affected by the value of the above four key parameters, and the value ranges from 1.9 to 7.2 μm, which indicates that the micrometer dust particles above this value can be removed. Considering the value of the above key parameters, and considering the ease of installation and integration for the device, the moving speed of the wire material is regulated at 0.1-3 m/s, and the length l of the tubular dust-collecting anode plate 12 is 100˜300 mm.

In some embodiments of the present disclosure, specific parameter settings in the wire material cleaning method are shown in Table 1.

TABLE 1

| | | a/cm | | | | | | | | | | | | | | | |
|---|---|---|---|---|---|---|---|---|---|---|---|---|---|---|---|---|---|
| | | 0.1 | | | | | | | | 0.15 | | | | | | | |
| | | b/cm | | | | | | | | | | | | | | | |
| | | 1 | | | | 2 | | | | 1 | | | | 2 | | | |
| U/kV | | 14 | | 26 | | 19 | | 55 | | 16 | | 25 | | 22 | | 55 | |
| xₘᵢₙ/cm | xₘₐₓ/cm | 0.11 | 0.2 | 0.2 | 0.3 | 0.12 | 0.2 | 0.32 | 0.4 | 0.16 | 0.25 | 0.25 | 0.3 | 0.17 | 0.3 | 0.40 | 0.45 |

| | | | | | | | | | | | | | | | | |
|---|---|---|---|---|---|---|---|---|---|---|---|---|---|---|---|---|
| dₚₘᵢₙ/μm | 1.9 | 6.2 | 1.8 | 4.1 | 2.1 | 5.8 | 1.8 | 2.8 | 2.1 | 5.0 | 2.1 | 3.0 | 2.4 | 7.2 | 2.1 | 2.6 |
| t_{c}/ms | 47.6 | 70.1 | 66.9 | 46.9 | 7.9 | 42.6 | 31.5 | 34.0 | 42.2 | 93.3 | 42.2 | 51.2 | 26.6 | 55.7 | 32.2 | 51.2 |
| t_{col}/ms | 13.4 | 4.1 | 4.1 | 1.8 | 89.4 | 32.3 | 12.4 | 8.0 | 6.3 | 2.6 | 2.5 | 1.8 | 43.6 | 14.5 | 7.9 | 6.4 |
| tₜₒₜₐₗ/ms | 61.0 | 74.2 | 71.0 | 48.7 | 97.3 | 74.9 | 43.9 | 42.0 | 48.5 | 95.9 | 44.7 | 53.0 | 70.2 | 70.2 | 40.1 | 57.6 |

| | |
|---|---|
| v/m/s | 0.1~3 |
| l/mm | 100~300 |

Referring to FIG. 1, in some embodiments of the present disclosure, the wire end of the wire material is led from the unwinding spool 41, and passes through the tension wheel 42, the first guide wheel 43, the charged dust collecting unit, and the second guide wheel 44; and the wire end is adhered to the winding spool 45 after wrapping around the winding spool 45 by one circle. The spool is installed and the DC power source is turned on, wherein the unwinding spool 41 and the winding spool 45 rotate synchronously under the driving of the servomotor 47; and at the same time, the winding spool 45 further moves reciprocally forward and backward, so that the wire material passes through the charge dust collection system. The particles are charged in the system and get rid of the surface of the wire material under the action of the electric field force, so as to be adsorbed on the dust collection plate. The cleaned wire material is gradually wound on the winding spool 45 and is evenly arrayed. The tension rod 46 provides the winding tension force during the winding process of the wire material.

In some embodiments of the present disclosure, the wire material is properly loosed and tensioned during the movement process. For the wire material with a diameter of 18˜30 μm, the wire tension force is 1.2˜3 gf.

In some embodiments of the present disclosure, the wire material includes the bonding wire.

Some embodiments of the present disclosure further provide the use of the above wire material cleaning method in the bonding wire cleaning.

### Example 1

Referring to FIG. 1, the bonding wire cleaning device provided by the Example included a charged dust collecting unit, a power source, and a conveying unit.

The charged dust collecting unit included a corona wire 11 and a tubular dust-collecting anode plate 12, and the corona wire 11 was located at a center position in an axial direction of the tubular dust-collecting anode plate 12; the corona wire 11 was coaxial with the tubular dust-collecting anode plate 12; the corona wire 11 had a radius a of 0.1 cm and a length of 120 mm, and was made of stainless steel; and the tubular dust-collecting anode plate 12 had a thickness of 2 mm, an inner circle radius b of 1 cm, and a length l of 100 mm.

The corona wire 11 was connected to the negative electrode of the power source 2; and the tubular dust-collecting anode plate 12 was connected to the positive electrode of the power source 2, and was grounded.

The power source 2 included a DC/DC direct current boost module.

The conveying unit included an unwinding spool 41, a tension wheel 42, a first guide wheel 43, a second guide wheel 44, and a winding spool 45 arranged in sequence; and the charged dust collecting unit was arranged between the first guide wheel 43 and the second guide wheel 44, wherein a tension rod 46 was arranged on the tension wheel 42; the unwinding spool 41 was connected to the servomotor 47; and the winding spool 45 was connected to the servomotor 47.

The bonding wire cleaning method provided by the Example adopted the above bonding wire cleaning device, including the following steps.

The wire end of the wire material was led from the unwinding spool 41, and passed through the tension wheel 42, the first guide wheel 43, the charged dust collecting unit, and the second guide wheel 44; and the wire end was adhered to the winding spool 45 after wrapping around the winding spool 45 by one circle. The spool was installed and the DC power source was turned on, wherein the unwinding spool 41 and the winding spool 45 rotated synchronously under the driving of the servomotor 47; and at the same time, the winding spool 45 further moved reciprocally forward and backward, so that annealed bonding wire with a diameter of 18˜30 μm moved at a moving speed of 1.5 m/s (v) under the wire tension force of 1.2˜3 gf in a direction parallel to the corona wire 11 and passed through the charged dust collecting unit. After the particles on the surface of the bonding wire were charged and collected dust, the cleaned bonding wire was obtained, wherein the cleaned wire material was gradually wound on the winding spool 45 and was evenly arrayed.

The DC voltage (U) supplied by the power source 2 between the corona wire 11 and the tubular dust-collecting anode plate 12 was 25 kV. In the charged dust collecting unit, the electric field strength on the surface of the corona wire 11 was 109 kV/cm, which was higher than the initial electric field strength (E_{c} was 58 kV/cm), and it satisfied the requirement of the corona discharge, so as to generate a large amount of free electrons and positive ions, i.e., gas ionization. The space electric field strength is shown in FIG. 3.

In the charged dust collecting unit, the bonding wire was parallel to the corona wire 11; the bonding wire was on the horizontal side of the corona wire 11; and the center distance (x) between the bonding wire and the corona wire 11 was 0.2 cm. The bonding wire was located outside the corona region, which avoided that the air gap between the bonding wire and the corona wire air gap was broken through to burn the bonding wire, and at the same time ensured that the particles on the surface of the bonding wire were effectively charged.

In the charged dust collecting unit, the positive ions in the space were immediately attracted by the corona wire and lost their charge; and the free electrons moved toward the tubular dust-collecting anode plate under the action of the electric field, so as to fill the space between two electrodes. When the free electrons collided with the particles on the surface of the bonding wire, the particles were negatively charged, as shown in FIG. 3. At this time, the particles were subject to the van der Waals gravitational force and electric field repulsive force. The typical values of No and K under atmospheric temperature conditions were taken as N₀=5×10¹⁴/m³ and K=2.2×10⁻⁴ m²/(s·V), and then the charging time constant τ=0.002 s. When the time t_{c}=τ, the charge quantity of the particles was half of the saturation charge; and it took x=0.2 cm, a=0.1 cm, b=1 cm, dₚₘᵢₙ=1.9 μm, U=25 kV, Z=0.4 nm, and εᵣ=5. When t=t_{c}=0.047 s, the charge quantity qₚ=1.161×10⁻¹⁵ C, and the charging stage ended.

When t>t_{c} and Fₑ>Fᵥ, the particles got rid of the adsorption of the bonding wire and moved towards the tubular dust-collecting anode plate, and particles with the particle size larger than 1.9 μm entered into the dust collection stage. During the dust collection process, the particles were subjected to the swing force of the air and the electric field force. The migration velocity of particles is shown in FIG. 5. If it took x=0.2 cm, a=0.1 cm, b=1 cm, dₚₘᵢₙ=1.9 μm, U=25 kV, t_{c}=47 ms, and t_{col}=3.97 ms, l>0.0765 m for v=1.5 m/s, so that l=100 mm could meet the requirement for collecting dust particles with the particle size larger than 1.9 μm (dₚₘᵢₙ).

The bonding wire cleaning method of the Example could effectively remove particles with the particle size larger than 1.9 μm (dₚₘᵢₙ).

### Cleaning Effect.

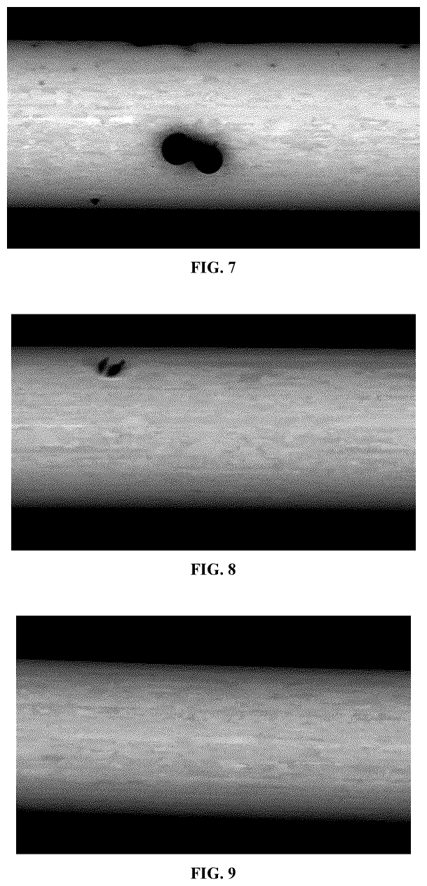

The surface morphologies of the uncleaned bonding wire, the ultrasonically cleaned bonding wire, and the cleaned bonding wires in Example 1 are shown in FIGS. 7, 8, and 9. It can be seen from FIG. 7˜FIG. 9 that the surface of the uncleaned bonding wire is covered by a large number of black particles with a particle size of 2˜10 μm; and there are a small amount of particles on the surface of the ultrasonically cleaned bonding wire; and there are no black particles on the surface of the bonding wire cleaned by the bonding wire cleaning method in Example 1, which has the best cleaning effect.

### Example 2

The bonding wire cleaning device provided by the Example included the charged dust collecting unit, the power source, and the conveying unit.

The charged dust collecting unit included the corona wire 11 and the tubular dust-collecting anode plate 12, and the corona wire 11 was located at a center position in the axial direction of the tubular dust-collecting anode plate 12; the corona wire 11 was coaxial with the tubular dust-collecting anode plate 12; the corona wire 11 had the radius a of 0.15 cm and the length of 180 mm, and was made of stainless steel; and the tubular dust-collecting anode plate 12 had the thickness of 2 mm, the inner circle radius b of 2 cm, and the length l of 150 mm.

The corona wire 11 was connected to the negative electrode of the power source 2; and the tubular dust-collecting anode plate 12 was connected to the positive electrode of the power source 2, and was grounded.

The power source 2 included the DC/DC direct current boost module.

The conveying unit included the unwinding spool 41, the tension wheel 42, the first guide wheel 43, the second guide wheel 44, and the winding spool 45 arranged in sequence; and the charged dust collecting unit was arranged between the first guide wheel 43 and the second guide wheel 44, wherein the tension rod 46 was arranged on the tension wheel 42; the unwinding spool 41 was connected to the servomotor 47; and the winding spool 45 was connected to the servomotor 47.

The bonding wire cleaning method provided by the Example adopted the above bonding wire cleaning device, including the following steps.

The wire end of the wire material was led from the unwinding spool 41, and passed through the tension wheel 42, the first guide wheel 43, the charged dust collecting unit, and the second guide wheel 44; and the wire end was adhered to the winding spool 45 after wrapping around the winding spool 45 by one circle. The spool was installed and the DC power source was turned on, wherein the unwinding spool 41 and the winding spool 45 rotated synchronously under the driving of the servomotor 47; and at the same time, the winding spool 45 further moved reciprocally forward and backward, so that annealed bonding wire with a diameter of 18˜30 μm moved at a moving speed of 2 m/s (v) under the wire tension force of 1.2˜3 gf in the direction parallel to the corona wire 11 and passed through the charged dust collecting unit. After the particles on the surface of the bonding wire were charged and collected dust, the cleaned bonding wire was obtained, wherein the cleaned wire material was gradually wound on the winding spool 45 and was evenly arrayed.

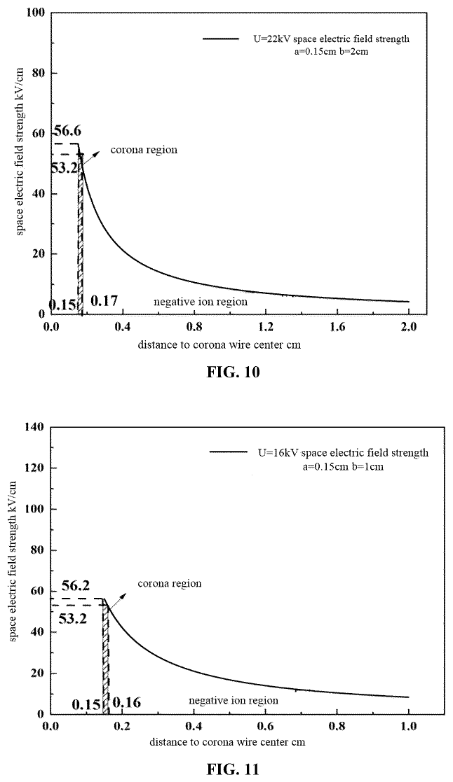

The DC voltage (U) supplied by the power source 2 between the corona wire 11 and the tubular dust-collecting anode plate 12 was 22 kV. In the charged dust collecting unit, the electric field strength on the surface of the corona wire 11 was 56.6 kV/cm, which was higher than the initial electric field strength (E_{c} was 53.2 kV/cm), and it satisfied the requirement of the corona discharge, so as to generate a large amount of free electrons and positive ions, i.e., gas ionization. The space electric field strength is shown in FIG. 10.

In the charged dust collecting unit, the bonding wire was parallel to the corona wire 11; the bonding wire was on the horizontal side of the corona wire 11; and the center distance (x) between the bonding wire and the corona wire 11 was 0.17 cm. The bonding wire was located outside the corona region, which avoided that the air gap between the bonding wire and the corona wire air gap was broken through to burn the bonding wire, and at the same time ensured that the particles on the surface of the bonding wire were effectively charged.

In the charged dust collecting unit, the positive ions in the space were immediately attracted by the corona wire and lost their charge; and the free electrons moved toward the tubular dust-collecting anode plate under the action of the electric field, so as to fill the space between two electrodes. When the free electrons collided with the particles on the surface of the bonding wire, the particles were negatively charged. It took x=0.17 cm, a=0.1 cm, b=2 cm, dₚₘᵢₙ=2.4 μm, U=22 kV, Z=0.4 nm, and &, =5. When 1=1 (=26.6 ms, the charge quantity qₚ=1.594×10⁻¹⁵ C, and the charging stage ended. When t>the and Fₑ>Fᵥ, the particles got rid of the adsorption of the bonding wire and moved towards the tubular dust-collecting anode plate, and particles with the particle size larger than 2.4 μm entered into the dust collection stage. During the dust collection process, the particles were subjected to the swing force of the air and the electric field force. If it took x=0.17 cm, a=0.1 cm, b=2 cm, dₚₘᵢₙ=2.4 μm, U=22 kV, t_{c}=26.6 ms, and t_{col}=43.6 ms, l>0.1403 m for v=2 m/s, so that l=150 mm could meet the requirement for collecting dust particles with the particle size larger than 2.4 μm (dₚₘᵢₙ). The bonding wire cleaning method of the Example could effectively remove particles with the particle size larger than 2.4 μm (dₚₘᵢₙ).

### Example 3

The bonding wire cleaning device provided by the Example included the charged dust collecting unit, the power source, and the conveying unit.

The charged dust collecting unit included the corona wire 11 and the tubular dust-collecting anode plate 12, and the corona wire 11 was located at the center position in the axial direction of the tubular dust-collecting anode plate 12; the corona wire 11 was coaxial with the tubular dust-collecting anode plate 12; the corona wire 11 had the radius a of 0.15 cm and the length of 180 mm, and was made of stainless steel; and the tubular dust-collecting anode plate 12 had the thickness of 2 mm, the inner circle radius b of 1 cm, and the length l of 150 mm.

The corona wire 11 was connected to the negative electrode of the power source 2; and the tubular dust-collecting anode plate 12 was connected to the positive electrode of the power source 2, and was grounded.

The power source 2 included the DC/DC direct current boost module.

The conveying unit included the unwinding spool 41, the tension wheel 42, the first guide wheel 43, the second guide wheel 44, and the winding spool 45 arranged in sequence; and the charged dust collecting unit was arranged between the first guide wheel 43 and the second guide wheel 44, wherein the tension rod 46 was arranged on the tension wheel 42; the unwinding spool 41 was connected to the servomotor 47; and the winding spool 45 was connected to the servomotor 47.

The bonding wire cleaning method provided by the Example adopted the above bonding wire cleaning device, including the following steps.

The wire end of the wire material was led from the unwinding spool 41, and passed through the tension wheel 42, the first guide wheel 43, the charged dust collecting unit, and the second guide wheel 44; and the wire end was adhered to the winding spool 45 after wrapping around the winding spool 45 by one circle. The spool was installed and the DC power source was turned on, wherein the unwinding spool 41 and the winding spool 45 rotated synchronously under the driving of the servomotor 47; and at the same time, the winding spool 45 further moved reciprocally forward and backward, so that annealed bonding wire with a diameter of 18˜30 μm moved from the unwinding spool at the moving speed of 2 m/s (v) under the wire tension force of 1.2˜3 gf in the direction parallel to the corona wire 11 and passed through the charged dust collecting unit. After the particles on the surface of the bonding wire were charged and collected dust, the cleaned bonding wire was obtained, wherein the cleaned wire material was gradually wound on the winding spool 45 and was evenly arrayed.

The DC voltage (U) supplied by the power source 2 between the corona wire 11 and the tubular dust-collecting anode plate 12 was 16 kV. In the charged dust collecting unit, the electric field strength on the surface of the corona wire 11 was 56.2 kV/cm, which was higher than the initial electric field strength (E_{c} was 53.2 kV/cm), and it satisfied the requirement of the corona discharge, so as to generate a large amount of free electrons and positive ions, i.e., gas ionization. The space electric field strength is shown in FIG. 11.

In the charged dust collecting unit, the bonding wire was parallel to the corona wire 11; the bonding wire was on the horizontal side of the corona wire 11; and the center distance (x) between the bonding wire and the corona wire 11 was 0.16 cm. The bonding wire was located outside the corona region, which avoided that the air gap between the bonding wire and the corona wire air gap was broken through to burn the bonding wire, and at the same time ensured that the particles on the surface of the bonding wire were effectively charged.

In the charged dust collecting unit, the positive ions in the space were immediately attracted by the corona wire and lost their charge; and the free electrons moved toward the tubular dust-collecting anode plate under the action of the electric field, so as to fill the space between two electrodes. When the free electrons collided with the particles on the surface of the bonding wire, the particles were negatively charged. It took x=0.16 cm, a=0.15 cm, b=1 cm, dₚₘᵢₙ=2.1 μm, U=16 kV, Z=0.4 nm, and εᵣ=5. When t=t_{c}=42.2 ms, the charge quantity qₚ=1.322×10⁻¹⁵ C, and the charging stage ended. When t>t_{c} and Fₑ>Fᵥ, the particles got rid of the adsorption of the bonding wire and moved towards the tubular dust-collecting anode plate, and particles with the particle size larger than 2.1 μm entered into the dust collection stage. During the dust collection process, the particles were subjected to the swing force of the air and the electric field force. It took x=0.16 cm, a=0.1 cm, b=2 cm, dₚₘᵢₙ=2.1 μm, U=16 kV, t_{c}=42.2 ms, and t_{col}=6.3 ms, l>0.1456 m for v=3 m/s, so that l=150 mm could meet the requirement for collecting dust particles with the particle size larger than 2.1 μm (dₚₘᵢₙ). The bonding wire cleaning method of the Example could effectively remove particles with the particle size larger than 2.1 μm (dₚₘᵢₙ).

Finally, it should be noted that the above embodiments are only used to illustrate the technical solutions of the present disclosure, and not to restrict it. Although the present disclosure is described in detail with reference to the foregoing embodiments, a person of ordinary skill in the art should understand that it is still possible to modify the technical solutions recorded in the foregoing embodiments or to make equivalent substitutions for some or all of the technical features therein; and these modifications or replacements do not take the essence of the corresponding technical solutions out of the scope of the technical solutions of the embodiments of the present disclosure.

1. A wire material cleaning device, comprising a charged dust collecting unit, wherein
the charged dust collecting unit comprises a corona wire and a tubular dust-collecting anode plate, and the corona wire is located at a center position in an axial direction of the tubular dust-collecting anode plate.

2. The wire material cleaning device according to claim 1, comprising at least one of following features (1) to (5):
(1) a diameter of the corona wire is 0.2˜0.3 cm;
(2) a material of the corona wire comprises stainless steel;
(3) an inner circle radius of the tubular dust-collecting anode plate is 1˜2 cm;
(4) a length of the tubular dust-collecting anode plate is 100˜300 mm; or
(5) a material of the tubular dust-collecting anode plate comprises stainless steel or aluminum alloy.

3. The wire material cleaning device according to claim 2, wherein in the charged dust collecting unit, a center distance between the wire material and the corona wire is 0.11˜0.45 cm; and/or
a voltage applied to the charged dust collecting unit is 14˜55 kV.

4. The wire material cleaning device according to claim 3, wherein the wire material cleaning device further comprises a power source, wherein the corona wire is connected to a negative electrode of the power source, and the tubular dust-collecting anode plate is connected to a positive electrode of the power source; and/or
the wire material cleaning device further comprises a conveying unit; the conveying unit comprises an unwinding spool, a tension wheel, a first guide wheel, a second guide wheel, and a winding spool arranged in sequence; and the charged dust collecting unit is arranged between the first guide wheel and the second guide wheel.

5. A wire material cleaning method, adopting the wire material cleaning device according to claim 1, and comprising following steps:
moving a wire material to be cleaned in a direction parallel to the corona wire and passing through the charged dust collecting unit, and charging particles on a surface of the wire material and collecting dust, so as to obtain a wire material after cleaned.

6. The wire material cleaning method according to claim 5, satisfying a following relation: U>30 Maδ(1+0.3/\sqrt{aδ})ln(b/a), where U is a DC voltage applied by a power source between the corona wire and the tubular dust-collecting anode plate in kV; M is a surface roughness coefficient of the corona wire; δ is a gas relative density; a is a radius of the corona wire in cm; and b is an inner circle radius of the tubular dust-collecting anode plate in cm.

7. The wire material cleaning method according to claim 6, satisfying the following relation
$$x > \frac{U}{30 M δ ( 1 + 0.3 / \sqrt{a δ} ) ln ( b / a )} ,$$
where x is a center distance between the wire material and the corona wire in cm.

8. The wire material cleaning method according to claim 7, satisfying a following relation: l>v·(t_{c}+t_{col}), where l is a length of the tubular dust-collecting anode plate in m; t_{c} is a charging duration in s; t_{col} is a dust collection duration in s; and v is a moving speed of the wire material in m/s;
$${t}_{c} = \frac{τ A {d}_{p}}{6 π {q}_{s} {Z}^{2} {E}_{x} - A {d}_{p}} ,$$
where τ is a charging time constant in s; A is a van der Waals Hamaker constant between the particles and the wire material; dₚ is an equivalent diameter of the particles in m; qₛ is a saturation charge quantity of the particles in C; Z is a distance between the particles and the surface of the wire material in m; and
$${E}_{x} = \frac{U}{x ln ( b / a )}$$
in kV/cm; and
$${t}_{col} = \frac{7 {μl n}^{2} ( b / a )}{5 {ε}_{0} {d}_{p} {U}^{2}} {\int }_{x}^{b} {r}^{2} ,$$
where μ is an air viscosity coefficient in Pa·s; ε₀ is a vacuum dielectric constant; and r is a distance between the particles and a center of the corona wire in cm.

9. The wire material cleaning method according to claim 8, wherein a particle size of the particles removed by the wire material cleaning method satisfies a following relation:
$${d}_{p} \geq \frac{A ( {ε}_{r} + 2 )}{18 {π}^{2} {Z}^{2} {E}_{x}^{2} {ε}_{0} {ε}_{r}} ,$$
where A is a van der Waals Hamaker constant between the particles and the wire material; Z is the distance between the particles and the surface of the wire material in m;
$${E}_{x =} \frac{U}{x ln ( b / a )} ,$$
where Eₓ is an electric field strength at the wire material in kV/cm; ε₀ is the vacuum dielectric constant; and εᵣ is a relative dielectric constant of the particles.

10. Use of the wire material cleaning method according to claim 5 in bonding wire cleaning.

11. The wire material cleaning method according to claim 5, comprising at least one of following features (1) to (5):
(1) a diameter of the corona wire is 0.2˜0.3 cm;
(2) a material of the corona wire comprises stainless steel;
(3) an inner circle radius of the tubular dust-collecting anode plate is 1˜2 cm;
(4) a length of the tubular dust-collecting anode plate is 100˜300 mm; or
(5) a material of the tubular dust-collecting anode plate comprises stainless steel or aluminum alloy.

12. The wire material cleaning method according to claim 11, wherein in the charged dust collecting unit, a center distance between the wire material and the corona wire is 0.11˜0.45 cm; and/or
a voltage applied to the charged dust collecting unit is 14˜55 kV.

13. The wire material cleaning method according to claim 12, wherein the wire material cleaning device further comprises a power source, wherein the corona wire is connected to a negative electrode of the power source, and the tubular dust-collecting anode plate is connected to a positive electrode of the power source; and/or
the wire material cleaning device further comprises a conveying unit; the conveying unit comprises an unwinding spool, a tension wheel, a first guide wheel, a second guide wheel, and a winding spool arranged in sequence; and the charged dust collecting unit is arranged between the first guide wheel and the second guide wheel.
